(19) United States
(12) Patent Application Publication
(10) Pub. No.: US 2009/0157465 A1
(43) Pub. Date: Jun. 18, 2009

(54) METHOD FOR MAPPING ANTICIPATED FUTURE EVENTS IN A DOMAIN

(76) Inventor: Donald Heathfield, Cambridge, MA (US)

Correspondence Address: Donald;Heathfield, Unti 9, 111 Trowbridge Street, Cambridge, MA, 02138, US

(21) Appl. No.: 12/356,794

(22) Filed: Jan. 21, 2009

Related U.S. Application Data
(63) Continuation-in-part of application No. 11/405,192, filed on Apr. 17, 2006.

(51) Int. Cl. G06Q 10/00

(52) U.S. Cl. 705/8

(57) ABSTRACT

Disclosed is a method for mapping anticipated future events in a domain. A multidimensional event field is assembled to include a depository of events related to the domain. The event field includes a plurality of dimensions. The depository of events from the event field is assessed to formulate at least one subset having high probability anticipated future events. At least one future scenario is extracted from the event field based on assessment of the depository of events. Each of the at least one future scenario represents a specific picture about a future of the domain. The method of the present invention helps in enhancing ability of organizations to prepare for future; aids decision makers to create internal processes for anticipating risks and challenges that await the organizations; and develop strategies to deal with the risks and challenges.

### CROSS REFERENCE TO RELATED APPLICATION

This application is a continuation-in-part application of U.S. patent application Ser. No. 11/405,192, filed on Apr. 17, 2006.

### FIELD OF THE INVENTION

The present invention relates to event prediction, and more specifically to a method for mapping anticipated future events in a domain.

### BACKGROUND OF THE INVENTION

Executives of the top management in the present corporate environment are under tremendous pressure to make their companies more reactive, competitive, and resilient. The challenges faced by the organizations include increasing uncertainty and rapid changes in the external environment, on which, the organizations do not have any control. As such, the executives and the corporate leaders recognize that preparing their businesses for the future is one of their main priorities, since, being well positioned to react to surprises (incidents) when they occur is much better than merely being surprised when an incident occurs.

The internal complexity of global enterprises does not facilitate fast and coherent responses to strategic challenges. Most of the global enterprises in the present era do not have a sound future preparedness system to enable them to deal with risks associated with the enterprise's long term strategy.

Some of the challenges faced by organizations while preparing for the future include assembling a coherent picture of the future from a multitude of facts and opinions, presenting the future in a way that facilitates decision making, involving the maximum of people into scanning of the global environment, integrating and sharing information of different types from different sources, learning continuously to question assumptions and conclusions about the organization, making the information collection and assessment processes to work together as one, driving shared awareness of the future, control the progress towards future objectives in a better manner and building a future preparedness system for the organization. The organizations need to recognize the above challenges early, and make appropriate timely decisions to improve their ability to react to uncertainties and risks of the future. The responsibility of future challenges in business usually lies with personnel responsible for formulating corporate strategy, corporate foresight, and corporate intelligence. The personnel responsible for such decision making need to have a continuously updated, structured picture of the anticipated future events to enable them to prepare strategies for the future challenges faced by the organization. Such pictures of the anticipated future events need to be readily available to the business leaders to help them deal with the future events more efficiently.

While some organizations have built global communities that include representatives of planning, intelligence and other functions, the vast majority of businesses do not have effective systems for creating and sharing a common picture of the future. The organizations need a common repository of information and a shared space for dialogue about the future. To enable discussion, the organizations also need to present the picture of the future challenges in a clear and compelling way. While many foresight and scenario projects pursue the exploration of long-term strategic alternatives, majority of the organizations' decisions focus on a much shorter time horizon—from a few months to 3-5 years. As a result, such foresight projects catch decision-makers' attention too infrequently to create a permanent working engagement.

Attempts have been made in the past to address the issue of future preparedness by developing various methodologies. Some “Early Warning” systems have been developed to stress upon importance of good environmental scanning. However, such systems have failed to earn sufficient long-term management commitment. This can be attributed to companies failing to establish the right relationships and balance between tactical market intelligence activities, usually conducted by Business Units and the Sales and Marketing organizations, and the strategic intelligence work that focuses on ensuring the long-term competitive health of the enterprise. Another problem connected with the same may be the imbalance between the producers of foresight and its potential users.

Other approaches like the ‘Balanced Scorecard’ and ‘Strategy Map’ have been adopted by many businesses. These approaches aim at measuring organizations performance from four major perspectives: financial, customer, internal process, and learning and growth, “and”, creating a common visual framework that embeds the items on the balanced scorecard into a cause-and-effect chain. The Balanced Scorecard and a Strategy Map help the organizations to define and communicate their objectives and strategies in a cohesive, integrated and systematic way. However, these methodologies do not provide any process for looking at how the changes in business environment affect the validity and effectiveness of such methodologies.

While specific methods and traditions of exploring the future differ from enterprise to enterprise, scenario development, usually integrating many other methodologies at its earlier stages, plays a critical role in the majority of future exploration efforts.

As such, the existing methodologies do not systematically deal with ways to populate the future space i.e. systematically translating all available information about the future into anticipated events. Further, the existing methodologies do not provide for creating the picture of the future that can be analyzed, tracked and debated, and the same may be attributed to the disconnect between strategy development and resource allocation processes, and, broadly, the inability of many traditional management systems to link long-term and short-term perspectives. In most of the existing methodologies, the mapping is done by either creating milestones to future scenarios (by scenario consultants) or as projection of trend lines (economics, science). All such processes are done without creating a structured future space (so the information cannot be saved or analyzed), so, the results are difficult to compare. Further, no specific support software is available to assist the organizations in creating a structured future space.

Accordingly, what is needed is an approach to build a comprehensive strategic future management system for providing a structured picture of the future in which all information about anticipated future events is organized.

### SUMMARY OF THE INVENTION

In view of the foregoing disadvantages inherent in the prior arts, the general purpose of the present invention is to provide a method, and computer program for mapping anticipated future events of a domain and to include all the advantages of the prior art, and to overcome the drawbacks inherent therein.

In one aspect, the present invention provides a method for mapping anticipated future events in a domain. A multidimensional event field is assembled to comprise a depository of events related to the domain. The depository of events from the event field is assessed to formulate at least one subset having high probability anticipated future events. At least one future scenario is extracted from the event field based on assessment of the depository of events. Each of the at least one future scenario represents a specific picture about a future of the domain.

In another aspect, the present invention provides a method for assembling an event field of a domain. A plurality of factors impacting the domain is defined. The plurality of factors constitutes a dimension of the plurality of dimensions. Key repeating events are defined for each factor of the plurality of factors in the domain. A predecessor event and a follower event are defined for each event of the key repeating events. A first subset of anticipated future events is added to the event field. The first subset of anticipated future events occurs at known regular intervals. A second subset of anticipated future events is added to the event field by applying trends and projections on the each factor. A third subset of anticipated future events is added to the event field, based on predictions of developments in the domain by human experts. At least one first set of events related to the domain is identified for importing to the event field. The at least one first set of events form at least one existing scenario. At least one second set of events related to the depository of events is identified from the event field. The at least one second set of events form at least one additional scenario. A trigger point is identified for each of the at least one existing scenario and each of the at least one additional scenario. The trigger point is an event that initiates at least one of the at least one existing scenario and the at least one additional scenario. A fourth subset of anticipated future events is added to the event field based on wild cards and anticipated disruptions in the trends. At least one identifier data is added to the event field. The at least one identifier data is associated with the depository of events of the event field. The at least one identifier data forms an identifier data dimension of the plurality of dimensions. Probabilities are assigned to each event of the depository of events. Objectives and milestone events are identified. The objectives and the milestone events are associated with the event field. Strategic options and action plans are added to the event field. The depository of events is arranged along a time dimension of the plurality of dimensions.

In yet another aspect, the present invention provides a method for assessing a depository of events of an event field of a domain. The event field is examined to identify irrelevant events of the depository of events. The irrelevant events are eliminated from the event field. Impact of occurred events of the depository of events on anticipated future events in the event field is reviewed. Key anticipated future events of the anticipated future events are identified. Leading indicators of the key anticipated future events are defined and identified for tracking and setting milestone events. Probabilities of each of the key anticipated future events are evaluated. At least one existing scenario is reviewed for selecting at least one second set of events of the depository of events. The second set of events forms at least one additional scenario. The key anticipated future events of the event field are re-identified. Impact of the key anticipated future events on the domain is assessed. Risks and opportunities associated with the key anticipated future events are identified. Objectives and the milestone events associated with the depository of events are modified. Strategy options and action plans in the event field are reviewed.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following more detailed description and claims taken in conjunction with the accompanying drawings, wherein like elements are identified with like symbols, and in which:

FIG. 1 is a framework illustrating a two-dimensional view of an event field 100 of a domain, according to an exemplary embodiment of the present invention;

FIG. 2 illustrates a two dimensional spreadsheet software screen having the event field 100 assembled therein, according to an exemplary embodiment of the present invention;

FIG. 3 depicts a three dimensional view of the event field 100, according to an exemplary embodiment of the present invention;

FIG. 4 is a flow chart for mapping anticipated future events in a domain, according to an embodiment of the present invention;

FIGS. 5A and 5B illustrate a flowchart depicting a method for event field assembly 200, according to an exemplary embodiment of the present invention;

FIG. 6 illustrates a flowchart depicting a method for event field assessment 250, according to an exemplary embodiment of the present invention; and

FIG. 7 depicts an exemplary user interface 700 for enabling human experts to assemble and assess the event field, according to an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in methodologies and design modules. It should be emphasized, however, that the present invention is not limited to a particular method for mapping anticipated future events in a domain, as shown and described. Rather, the principles of the present invention may be used with a variety of methodologies and design modules for providing simplicity in mapping the anticipated future events in the domain. It is understood that various omissions, substitutions of equivalents are contemplated as circumstances may suggest or render expedient, but is intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a method for mapping anticipated future events. The present invention addresses the problem of creating a structured space (time-factor-identifier data) in which all information about the anticipated future events is organized. The present invention provides for a creation of a picture of the future from a depository of events, by the contributions from human experts. The present invention creates a permanent process of reevaluation and reassessment of the anticipated future events by continuously updating the picture of the future events, based on updated information of the anticipated future events. The method of the present invention helps in enhancing the ability of organizations to prepare for the future. The present invention aids decision makers to create internal processes of anticipating the risks and challenges that await the organizations, and develop strategies to deal with the risks and challenges proactively. By utilizing the methodologies of the present invention, organizations can drive the learning process, to help them to prepare for the future.

The present invention further provides a way of organizing and presenting decision-oriented information about the future, a way of synthesizing cross-time and cross-domain knowledge about the future, a way of continuously integrating and managing global and internal knowledge about the future, and a way of creating a permanent link between strategy, intelligence and learning.

The methodologies of present invention can be utilized by personnel responsible for strategy, planning and intelligence in governments (for example, State Departments, National Intelligence Council, Office of Conflict Monitoring and Prevention), corporate sectors (for example, planning, strategy, and IT strategy departments of corporate sectors), non-profit organizations, and other organizations dealing with building a global community around an important future issue.

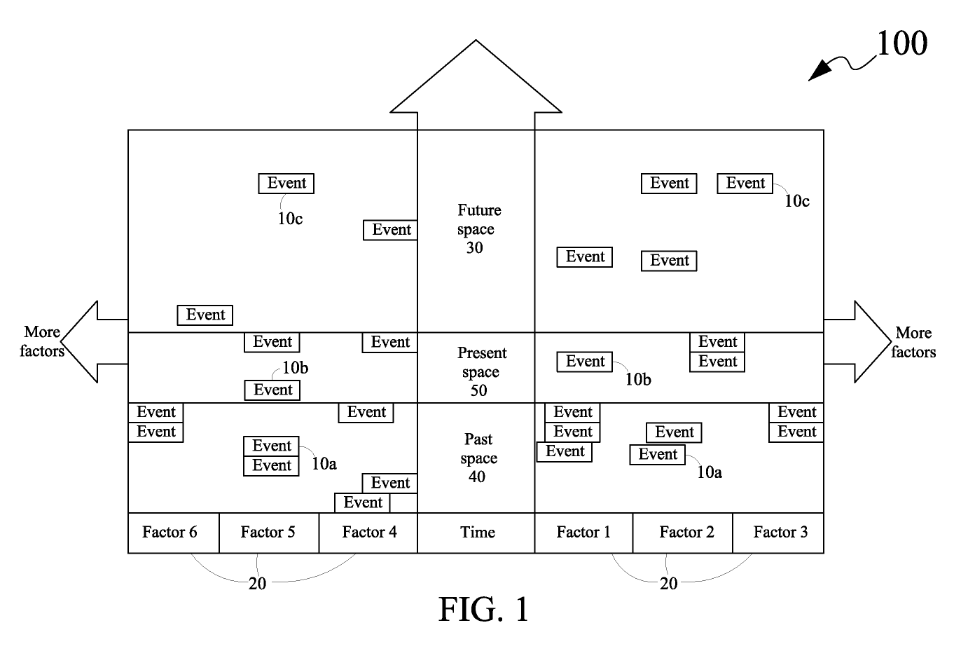

Referring to FIG. 1, a framework is shown, illustrating a two-dimensional view of an event field 100 of a domain. The domain (for example, US congress, Singapore, Defense Department) may be a geographical, topical area, an organization, and the like, for which the future events are being mapped. The event field 100 includes a depository of events, such as an event 10a, an event 10b and an event 10c, related to the domain. An event of the depository of events may be an occurrence, an activity or happening in the domain (who did (or will do) what to/with Whom, When and Why). The event may have occurred or may be anticipated to occur in future. Individuals involved in the domain may define significance of events related to the domain, and decide, whether such events need to be included in the event field 100. For example, a state of environment that is the domain, such as [symbol] 1=$1.19, as on Feb. 27, 2007, can be represented as the event 10c, i.e. a future event and a visit of the President of the US to India in March 2006 may also be an event 10a, i.e. an occurred event. The depository of events in the domain may be affected by internal forces or external forces, called as a plurality of factors 20. A factor of the plurality of factors 20 may be an internal factor (internal force within the domain), or an external factor (external force outside the domain). Consider a domain, such as, ‘Foreign Affairs’ of the US. A visit of president of the US to India in March 2006 may be an event in the domain. Political situation, economical situation, and the like, within the US may be considered as the internal factors affecting the domain ‘Foreign Affairs’. Further, the US-Pakistan relationship, political situation in South-East Asia, and the like, may be the external factors affecting the domain.

The depository of events (hereinafter, referred to as ‘events’) in the event field 100 may be depicted in a two-dimensional space, such as a computer screen, paper, and the like, as shown in FIG. 1. The events are shown along two dimensions. A first dimension, (depicted vertically) indicates a time of occurrence of each event. The time of occurrence may range from past to future. The first dimension will hereinafter be referred to as ‘time dimension’. A second dimension (depicted horizontally) indicates the plurality of factors 20 that impact the domain. Each event of the events is related to a factor of the plurality of factors 20. The second dimension will hereinafter be referred to as ‘factor dimension’. The event field 100 is also arranged along a third dimension (not shown) that indicates identifier data related to the events. The identifier data of an event may include a nature of the event, an implication of the event, a meaning of the event, actions to be taken on occurrence of the event and links and attachments related to the event. Further, the identifier data of an event may also include implications of the event, such as consequences, or anticipated consequences of the event. Furthermore, the third dimension may also be expressed in occurred events of the events or anticipated future events of the events. Hereinafter, the third dimension will be referred to as ‘data identifier dimension’. A future space 30 in the event field 100 corresponds to the anticipated future events that may occur in future, a past space 40 corresponds to the occurred events that have already occurred in the past, and a present space 50 corresponds to occurring events that are occurring in the present.

Depending on the needs of decisions makers of the domain, and availability of information related to the domain, density of the event field 100 may be defined, in terms of time increments, such as, seconds, minutes, hours, days, weeks, months, years, and the like). An event or a combination of a plurality of events may constitute a subset of the events of the event field 100. At least one subset may be extracted from the event field 100 for preparing a future map having the anticipated future events that impact the domain. Such extracted future maps may be used for requirements of strategy building, planning, intelligence presentations, and the like.

The event field 100 may be assembled in a space, or a computer screen, called as an assembly screen. The assembly screen includes the events that are put into the event field 100, without discrimination. The assembly screen may serve as a common interaction and collaboration tool for an expert community in the domain to collectively work on mapping, and assessing the anticipated future events of the domain. A version of the assembly screen that contains all events, but has not yet been analyzed and adjusted (treated) by experts of the expert community to eliminate mistakes and inconsistencies, may be called a raw assembly screen.

Various types of presentation screens may be derived from the assembly screen to fit specific purposes, levels of complexity and details of customer needs. For example, a basic presentation screen display may include internal factors arranged on the right, and the external factors arranged on the left. In a single scenario screen, a subset of the events may be depicted on the screen to represent one particular scenario of the domain's future. In a multiple scenario screen, the events may be grouped and presented in each category or column of factor, to reflect several possible future scenarios for the domain. Single factor screens may represent multiple scenarios in a single factor or category. Further, expert and source screens may represent events that have been extracted by one specific human expert (or a particular expert community) or one specific source, such as, Chinese experts, Strategic Forecasting Inc., and the like. Further, a tracking screen is a screen that may be used for tracking how actual events fit into specific scenarios that may be represented by multiple milestone events set at various times in the future. “Chain of events” screens show events that may be dependent on each other according to input coding, or other such logic.

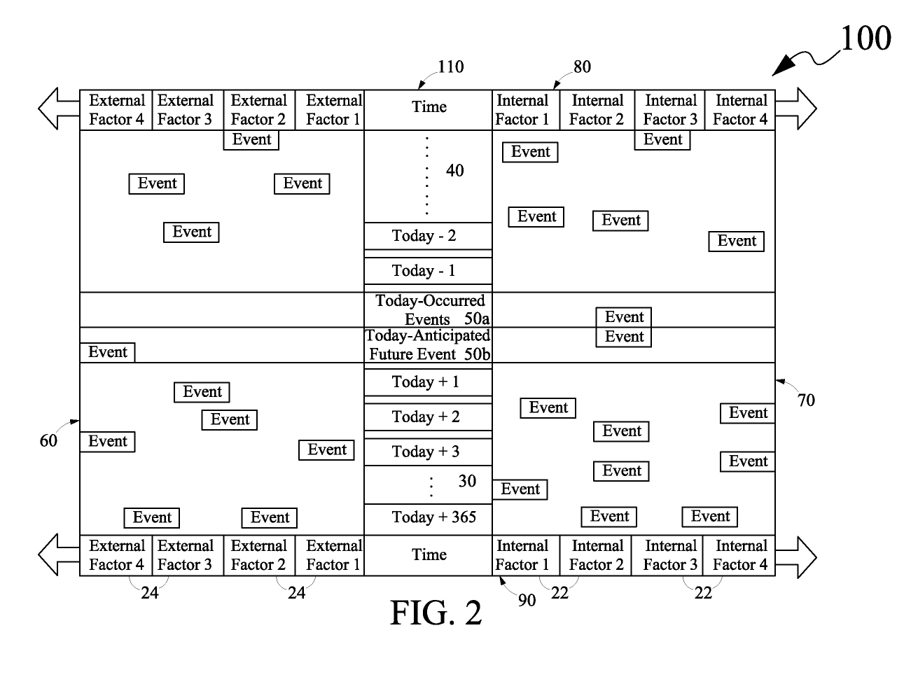

Referring to FIG. 2, the events in the event field 100 may be represented on a two dimensional spreadsheet software screen, along the time dimension and the factor dimension. The two dimensional spreadsheet software screen includes a left margin 60, a right margin 70, a top margin 80, and a bottom margin 90. The left margin 60, the right margin 70, the top margin 80, and the bottom margin 90 define a plurality of rows, and a plurality of columns. The plurality of columns, between the left margin 60 and the right margin 70, include a central column 110 that includes increments of time, such as days, weeks, months, quarters, years, and the like, organized in a manner, such that, the present space 50 is arranged in a middle portion of the central column 110. The present space 50 is distributed in two parts. A part 50a of the present space 50 may include time increments corresponding to the occurred events of the present day and a part 50b may include time increments corresponding to the anticipated future events of the present day. In an embodiment of the present invention, the future space 30 may be arranged below the present space 50 towards the bottom margin 90. The future space 30 may include time increments corresponding to the anticipated future events. Further, the past space 40 may be arranged above the present space 50 towards the top margin 80. The past space 40 may include time increments corresponding to past events arranged in the central column 110. For example, if the event field 100 of a domain has been defined for the month of April 2006, then, the central column 110 is organized in day increments, such that days in Aril 2006 are incremented from April 1 at a top field of the central column 110 to April 30 at a bottom field of the central column 110. A row of the plurality of rows along the bottom margin 90 of the two dimensional spreadsheet software screen includes internal factors 22, and external factors 24 organized in a manner, such that, the internal factors 22 are organized to the right of the central column 110 towards the right margin 70 and the external factors 24 are organized to the left of the central column 110 towards the left margin 60. (For example, if the domain is China, then one internal factor may be state-owned enterprises, and one external factor may be US trade policy with China).

Events are arranged in the two dimensional spreadsheet software screen based on the occurrence of an event at a particular time, and its relationship with the plurality of factors 20. The events are arranged in the event field 100 at an intersection of time and the plurality of factors 20 (the internal factors 22 or the external factors 24). If the event refers to several factors of the plurality of factors 20 at the same time, such events may be represented on the event field 100 corresponding to the several factors. In an embodiment of the present invention, each factor of the plurality of factors 20 may occupy a number of columns of the plurality of columns on the spreadsheet software screen to accommodate a large number of related events that may appear in a given time period. Each event may have a reference number defining a source, date, type, relationships with other events, number of places the each event is appearing, and the like. Events may be abbreviated in the spreadsheet software screen, and full text of the events may be extracted from the source. Also, reference numbers of the events may be obtained by right-clicking on the events in the spreadsheet software screen. In addition, the events may be coded to indicate a relationship of one event with another event or leading indicators or followers of other events or events that usually happen together. Such coding allows the extraction of a chain of related events from an event field 100. Furthermore, the coding allows a systematic analysis of the chain of events (the occurred events and the anticipated future events) to help in modeling and simulations.

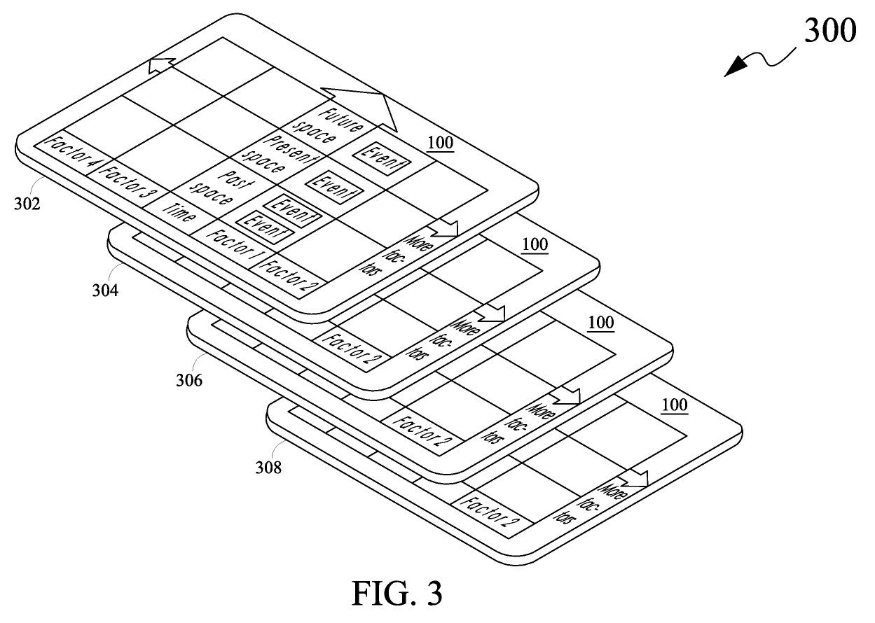

FIG. 3 depicts a three dimensional view 300 of the event field 100, according to an exemplary embodiment of the present invention. The three dimensional view 300 of the event field 100 may be viewable on a display screen, such as a Cathode Ray Tube (CRT) monitor, a Liquid Crystal Display (LCD) monitor, a touch screen device, and the like. The three dimensional view 300 depicts the event field 100 that includes the time dimension and the factor dimension. The identifier data dimension that forms the third dimension of the event field 100 is also depicted. An event of the events on the event field 100 may be related to a plurality of identifier data, such as a strategy 302, an objective 304, implications 306 and business environment 308. Further, the identifier data dimension may also include nature of the events, links and attachments related to the events, and the like.

The strategy 302 is an identifier data that represents information of actions to be taken on occurrence of an event in the event field 100. For example, the information of actions to be taken when an event, ‘Stock markets crashed’ occurs may be represented by the strategy 302.

The objective 304 is an identifier data that represents information of an objective for a particular event on the event field 100. For example, an event on the event field 100 may be ‘Lay-off 20% of the employees’ and the information of the objective for the event may indicate ‘Reduce Expenses’ on the objective 304.

The implications 306 represent information of meaning of the events of the event field 100. For example, the information of meaning of an event encoded as “X305”, may be represented on the implications 306. The information of the meaning may convey that the event relates to increase in inflation.

The business environment 308 represents information of business environment or business units that may be related to the domain or that may be impacted by the events occurring in the domain. For example, the information of business environment related to an event “Generation of revenue report” may include relevant information from operations units, sales units and marketing units of the domain.

It will be apparent to a person skilled in the art that the identifier data dimension includes the plurality of identifier data corresponding to the occurred events, the occurring events, and the anticipated future events. A method for mapping anticipated future events in the domain is explained in the following figures.

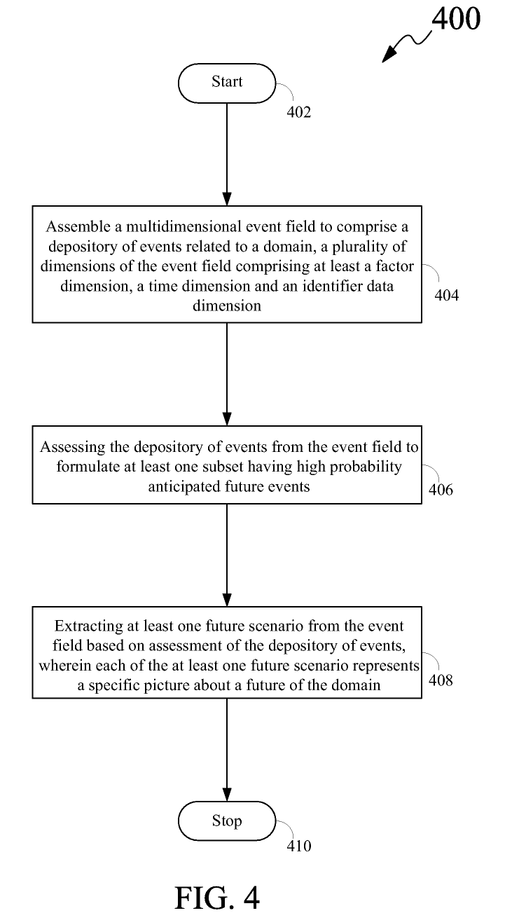

FIG. 4 is a flow chart depicting a method 400 for mapping the anticipated future events in the domain, according to an embodiment of the present invention. The method 400 begins at 402.

At 404, a multidimensional event field, such as the event field 100, is assembled to include a depository of events (also referred to as ‘events’) that are related to the domain. Examples of the domain include, but are not limited to, China, External affairs for the UK, sales target for a company A, and the like. The event field includes the plurality of dimensions, such as the time dimension, the factor dimension and the identifier data dimension, as explained previously. The event field may be assembled by a group of human experts in the domain.

At 406, the events are accessed from the event field to formulate at least one subset having high probability anticipated future events. For example, an expert may access events, such as market share of a company X, revenue of the company X, business development by the company X, and similar events, from the event field and anticipate future events in the domain of company X, with a high probability of occurrence.

At 408, at least one future scenario is extracted from the event field based on assessment of the events. Each of the at least one future scenario represents a specific picture about a future of the domain. At 410, the method 400 ends.

As explained previously, mapping the anticipated future events includes the process of assembling the event field 100 and assessing the event field 100. Hereinafter, the process of assembling the event filed 100 will be referred to as ‘event field assembly 200’. Further, assessing the event field 100 will hereinafter be referred to as ‘event field assessment 250’. The event field assembly 200 is a multi-step process of extracting the events that include, occurred events, the occurring events as well as the anticipated future events from various sources, thereby, assembling a structured picture of the future from a multitude of facts and opinions to present the future in a way that facilitates decision making. The events may originate from two main types of sources: human experts and automatic information extraction tools. The events may also originate from knowledge, trend projection, newswire, and the like. The events in the event field may be clearly identified by the source, and also by the level of reliability of the source. Events that are planned and scheduled need to be distinguished from those events that human experts simply expect to occur due to the logic of observed developments in the domain. The event field assembly 200 for the domain includes, organizing the anticipated future events in the event field, reviewing events that are already included, and adjusting the events based on the updated information. The picture of anticipated future (especially immediate future) in the domain achieves greater precision and depth with each iteration of steps included in the event field assembly 200. The event field assessment 250 is a continuous process performed by the human experts responsible for mapping, and assessing the anticipated future events of the domain. The event field assembly 250 includes reviewing and analyzing the event field of the domain, identifying trends and scenarios, evaluating probabilities of key events, and preparation of various presentation screens. The picture of the anticipated future (especially immediate future) in the domain achieves greater precision and depth with iteration of the steps included in the event field assessment 250.

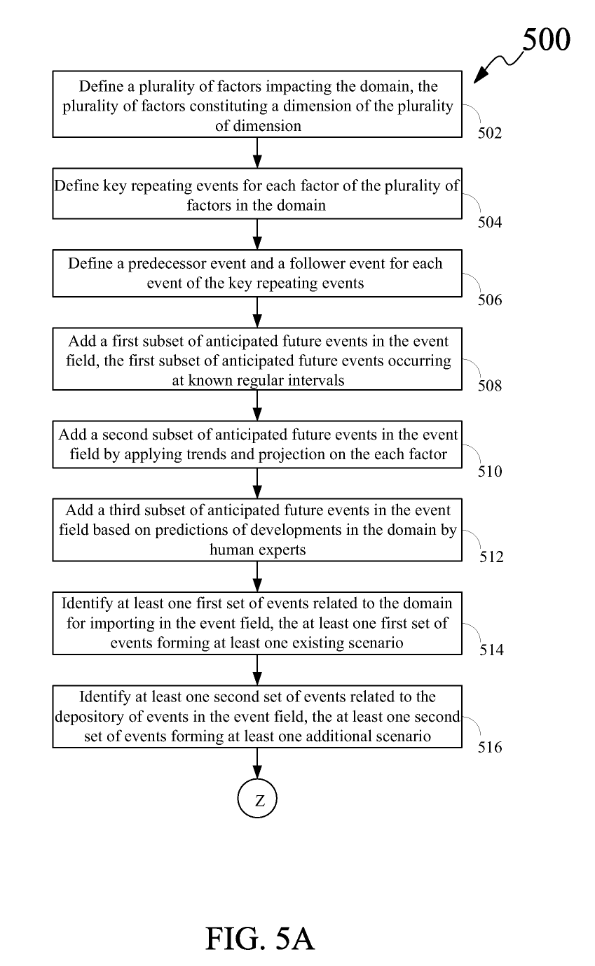

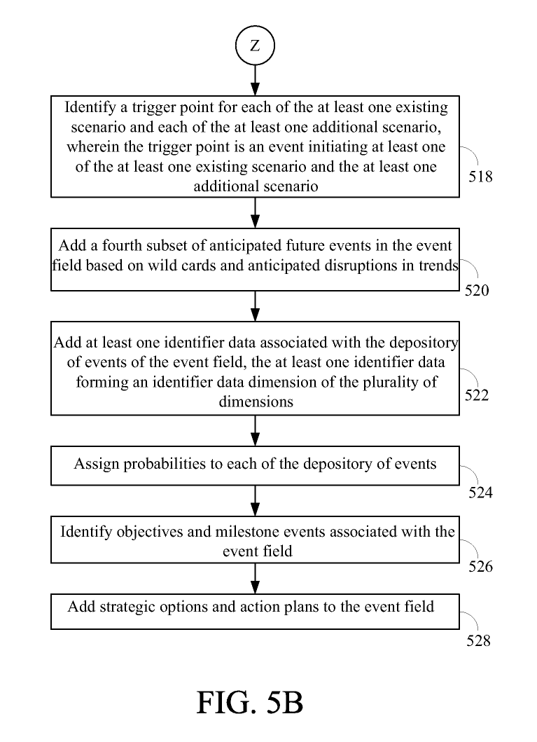

Referring now to FIGS. 5A and 5B, a flowchart illustrating a method 500 for the event field assembly 200 is shown. A domain may be defined. Examples of the domain may include an enterprise, or a country for which the future map is being prepared, such as China, Iraq, US Congress, Boston, Nuclear Industry, and the like. Further, a structure of an assembly screen for the event field of the domain may be defined. At step 502, the method 500 starts with defining a plurality of factors, such as the plurality of factors 20 that impact the domain. The plurality of factors constitutes a dimension of the plurality of dimensions, i.e. the factor dimension. More specifically, the internal factors and the external factors impacting the domain are defined. The plurality of factors is grouped into categories (if necessary). Further, the factors (or categories) are arranged by importance of their impact on the domain. In an embodiment of the present invention, the plurality of factors may be arranged from right to left in the plurality of columns of the assembly screen, with important factors closer to a central column, such as the central column 110 of the event field 100. The frequency of keywords being mentioned together in various sources may help determine the relative importance of a factor for a domain. For example, the keyword ‘communist party’ can be often associated with the domain ‘China’, and, accordingly, ‘communist party’ can be an important factor affecting the events of the domain ‘China’.

At 504, key repeating events for each factor of the plurality of factors in the domain are defined. The key repeating events refer to those events of the domain that repeat after regular intervals of time. For example, an event “Quarterly sales review” is repeated every quarter, i.e. every three months. Such key repeating events may be defined and arranged on the event field. In another example, if ‘China’ is defined as the domain, and ‘Communist Party’ is defined as the factor, then a key repeating event for the factor can be ‘Party Congress every four years’. Defining the key repeating events can be accomplished by a group of human experts, or by identifying a set of repeating events, or by using search software to input known patterns of events in the domain. The results of software based searches may be checked for consistency by the human experts. The human experts may input alternative dates for the key repeating events if it is anticipated that there may be a change in event patterns in the future.

At 506, a predecessor event and a follower event for each event of the key repeating events are defined. The predecessor event of a key repeating event may be defined as an event that occurs before the key repeating event. For example, an event, such as “generation of quarterly sales report” may be a predecessor event for the event “Quarterly sales review”. Further, the follower event of a key repeating event may similarly be defined as an event that occurs after the key repeating event. For example, an event, such as “Setting sales targets” may be a follower event for the event “Quarterly sales review”. Such follower events and predecessor events are defined for each key repeating event of the key repeating events defined. Based on the best available knowledge, human experts can identify and input the predecessor events and the follower events for the key repeating events that relate to each factor.

At 508, a first subset of anticipated future events is added in the event field. The first subset of anticipated future events occurs at known regular intervals. Such events may be obtained from human experts of the domain, or by scanning all available information sources such as web, newswire reports, and the like, to gather information pertaining to events with known dates related to the plurality of factors of the domain. The above process of gathering information from information sources and the human experts may be done continuously and information about the anticipated future events for multiple domains can be collected in the process. For example, a source with knowledge of situation in China anticipates that changes in the way the government finances State Owned Enterprises, will take place at a specific date.

At 510, a second subset of anticipated future events is added in the event field by applying trends and projections on the each factor. For example, an event “Reduction in selling price of a product A” may be anticipated to occur on applying trends and projections to a factor “Competition in a market for the product A”. Trends and projections may be applied to factors in the domain using additional columns beside the factor columns as necessary in the event field. Separate columns may be created to fill in short and long term trends. Economic, social, demographical, geopolitical and other trends may be expressed in the events. Economic data such as exchange rates, growth rates, and the like, may be input directly from forecasts. For example: value of dollar to RMB on specific date as an event, such as, Jun. 14, 2007−$1=8.26 RMB, rate of growth in China—8.3%. Geopolitical and other trends can be expressed as a description of a situation anticipated at a specific date according to trends. For each trend, there might be several scenarios. Such alternatives can be represented in side-by-side columns, and may be numbered and named to be ready for assessment and comparison.

At 512, a third subset of anticipated future events may be added to the event field based on predictions of developments in the domain by the human experts. For example, human experts in a domain “China” may predict an event “Civil war in China” that may be added to the event field as a part of the third subset. The human experts may add events that are likely to take place considering the knowledge human experts have on the domain and information already assembled in the event field. Events anticipated by human experts may represent the consequences of the events in the event field, events that are required to happen before an already scheduled event takes place, events that are bound to happen together (in parallel) with a high probability anticipated event.

At 514, at least one first set of events related to the domain may be identified for importing in the event field. The at least one first set of events form at least one existing scenario. A scenario may be defined as a picture of the future formed out of a subset of events. Such at least one first set of events is imported into the event field.

At 516, at least one second set of events related to the depository of events in the event field is identified. The at least one second set of events forms at least one additional scenario. The at least one second set of events are present on the event field and may be combined to form the at least one additional scenario.

At 518, a trigger point for each of the at least one existing scenario and each of the at least one additional scenario is identified. The trigger point is an event initiating at least one of the at least one existing scenario and the at least one additional scenario. More specifically, an event may be referred to as a trigger point if it initiates a scenario. For example, insolvency of a particular company X may have been the trigger point that initiated a financial “panic selling” scenario in fall of 2008.

Referring to FIG. 5B, at 520, a fourth subset of anticipated future events is added to the event field based on wild card events and anticipated disruptions in trends. The human experts may identify key disruptions in trends and wild card events that may occur and affect the domain, and include those events in the event field at appropriate columns of respective factors. Alternatively, each anticipated disruption may occupy a separate column in the event field to allow better tracing of events associated with this disruption.

At 522, at least one identifier data associated with the events is added to the event field. The at least one identifier data forms the identifier data dimension of the plurality of dimensions, as explained earlier. The at least one identifier data of the plurality of identifier data may include strategies, such as the strategy 302, objectives, such as the objective 304, implications, such as the implications 306, business environment, such as the business environment 308, links and attachments, nature of the events, and the like. The plurality of identifier data provides additional information of the events in the event field.

At 524, probabilities are assigned to each of the events. For example, a probability of 0.46 may be assigned to an event “Decrease in oil prices” for a domain import and export. The human experts may assign such probabilities based on calculations or predictions or based on information from other sources.

At 526, objectives and milestone events associated with the event field are identified. The objectives may be defined as events that are desirable to be achieved. For example, an event, “Shares of company X reach all-time high of 150 on the BSE” may be an objective. The objective may be an anticipated future event. A milestone event may be defined as an event that signifies an achievement in a domain. The milestone event may be an occurred event, an occurring event or an anticipated future event. For example, an event “50 years of Indian independence” may be a milestone event.

At 528, strategic options and action plans may be added to the event field. More specifically, information of the strategic options and the action plans may be added to the event field by the human experts of the domain. A strategic option or an action plan may be a set of actions that may be taken in response to a specific scenario or to reach a specific objective. For example, the set of actions may relate to starting a business in a specific country. The method 500 is continuously repeated at regular intervals from 504 to 528 to add greater precision, and depth in the event field of the domain. Further, the events are collated by this continuous repetition.

The key repeating events, the predecessor events, the follower events, the first subset of anticipated future events, the second subset of anticipated future events, the third subset of anticipated future events, the fourth subset of anticipated future events, the at least one first set of events and the at least one second set of events constitute the depository of events of the event field.

At least one factor of the plurality of factors may be utilized for building at least one future scenario. The human experts may select a factor, such as ‘security’ that has high impact on a domain, such as ‘national affairs’. The at least one future scenario may be built from the factor by the human experts. The human experts may utilize intelligence warnings, security reports, and similar sources to build the at least one scenario.

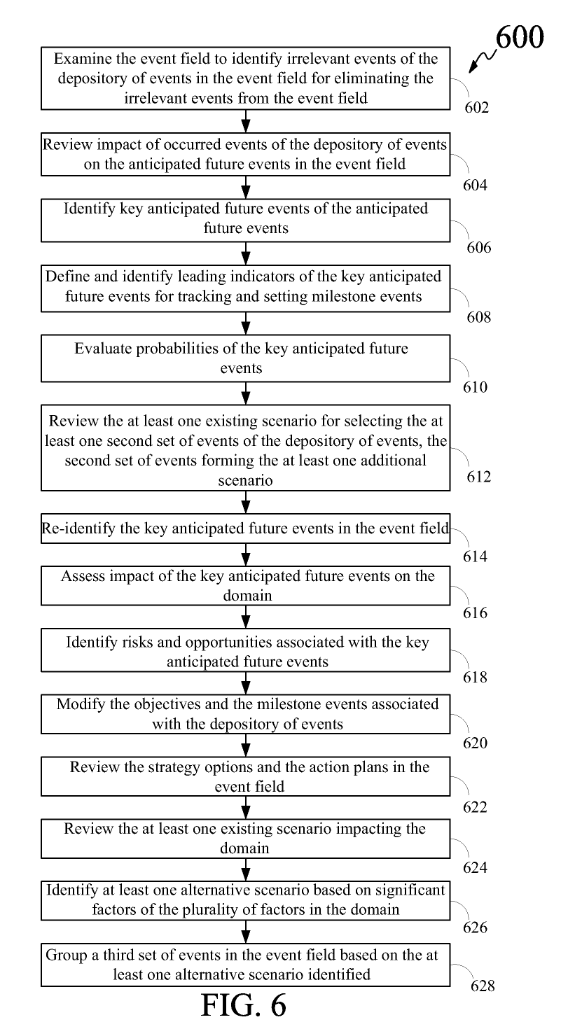

FIG. 6 illustrates a flowchart depicting a method for the event field assessment 250, according to an exemplary embodiment of the present invention. At 602, the event field (the events gathered during the event field assembly 200) is examined and irrelevant events are identified and eliminated. The event field of the domain is examined by the human experts to identify and correct mistakes and inconsistencies, and also make sure that the events put into the event field by automatic extraction tools correctly relate to the factors. The human experts identify areas where trends appear to mismatch with the events anticipated by the human experts or the automatic extraction tools. Such identified areas are further examined by the human experts. The human experts also identify disagreements and conflicts between information gathered from various sources and anticipations of various groups of human experts.

At 604, the human experts review impact of occurred events (that have recently occurred) on the anticipated future events. At 606, the human experts identify key anticipated future events (by conducting expert polls) in the event field that greatly affect the future directions of the developments in the domain. Also, a chain of events leading to the key anticipated future events is identified. Tools, such as collaboration software, may assist the human experts to work on the assessment of individual events in the event field by clicking on a particular event. The human experts may also assign a level of importance to the events, add comments about the events, and expected impacts and connections to other events. Furthermore, the human experts may estimate probabilities of key events, sets of events or entire scenarios on the event field using decision markets techniques.

At 608, leading indicators of the key anticipated future events are defined and identified by the human experts for tracking and setting the milestone events. For example, a leading indicator of an anticipated future event, such as recession, may be a decline in an index of confidence of purchasing managers.

At 610, probabilities of the key anticipated future events are evaluated. For example, a probability of an event ‘dissolution of government’ may be evaluated by the human experts in the domain of ‘current affairs’.

At 612, the at least one existing scenario is reviewed for selecting the at least one second set of events of the depository of events. The at least one second set of events form the at least one additional scenario. Further, as the event field is modified, a scenario of the at least one existing scenario may no longer be possible, thereby requiring a review of the at least one existing scenario to check viability of the at least one existing scenario in light of the modification.

At 614, the key anticipated future events in the event field are re-identified. At 616, the impact of the key anticipated future events on the domain is assessed by the human experts. For example, by using collaboration software, human experts may right-click on events to enter their assessment of the event's impact on other events and factors in the domain.

At 618, risks and opportunities associated with the key anticipated future events are identified by the human experts. For example, stock market value decline can be considered a risk because shareholders may lose their money. However, the stock market value decline may also be an opportunity to purchase shares at a cheaper price.

At 620, the objectives and the milestone events associated with the events are modified by the human experts. Such milestone events would help in tracking developments related to the domain. At 622, the strategy options and the action plans in the event field are reviewed by the human experts. At 624, the at least one existing scenario that impacts the domain is reviewed by the human experts. At 626, at least one alternative scenario is identified by the human experts, based on significant factors of the plurality of factors in the domain. At 628, a third set of events in the event field are grouped, based on the at least one alternative scenario identified by the human experts. The method 600 is repeated at regular intervals from 602 to 622 for improving organizational strategies to deal with the anticipated future events, thereby improving prediction of the anticipated future events.

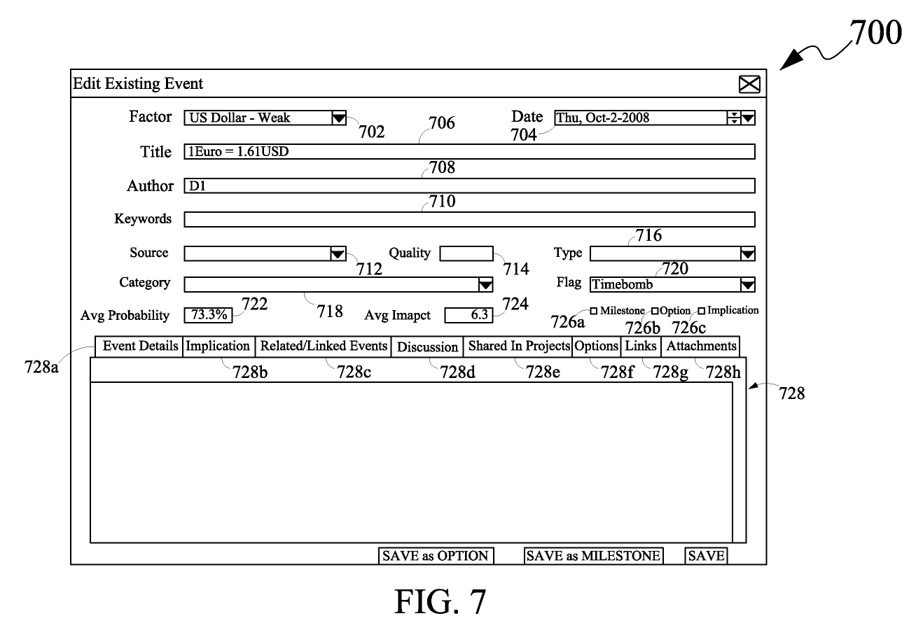

FIG. 7 depicts an exemplary user interface 700 for enabling human experts to assemble and assess an event field, such as the event field 100, according to an exemplary embodiment of the present invention. More specifically, the user interface 700 enables the human experts to add events and modify events of the event field. The user interface 700 includes a plurality of entries related to an event of the event field, such as a factor entry 702, a date entry 704, a title entry 706, an author entry 708, a keyword entry 710, a source entry 712, a quality entry 714, a type entry 716, a category entry 718, a flag entry 720, a probability entry 722, an impact entry 724, an event identification entry, such as a milestone 726a, an option 726b and an implication 726c, and an identifier data entry 728.

The factor entry 702 represents a factor of the plurality of factors that may be associated with the event. For example, a factor ‘US dollar weak’ may be associated with the event. The factor entry 702 forms the factor dimension of the event field. The date entry 704 represents a specific date on which the event occurs. The date may be a past date, a future date or a present date, making the event an occurred event, an anticipated event or an occurring event. For example, Thursday, Oct. 2, 2008, may be the date on which the event occurs. In an embodiment, the event may be a recurring event and the date entry 704 may be enabled to represent information of recurrence of the event. The date entry 704 forms the time dimension of the event field, as explained previously.

The title entry 706 represents a title that may be associated with the event. For example, a title ‘1 Euro=1.61 USD’ may be a title of the event. The author entry 708 represents names of the human experts who modify or add the events. The keyword entry 710 represents keywords related to the event that may be recorded for later analysis of features of the event, based on the keywords. The source entry 712 represents a source from which details of the event have been received. Examples of the source may include human experts, newswire reports, search tools, automatic extraction tools and the web.

The quality entry 714 may represent a quality of the source from which the details of the event have been received. The quality may be represented by a rating, a ranking, a number, a symbol, and the like. The type entry 716 may represent a type of the event. The type of event may be a scheduled event, a part of scenario, a speculation, an actual event, an expert opinion, and the like. The category entry 718 may represent a category of the event. Examples of the category of the event may include political event, economic event, scientific event, and the like. The flag entry 720 may represent a flag associated with the event, for example, ‘time bomb’. Examples of values of the flag associated with the event may include alert, high importance, invitation for discussion, and the like.

The probability entry 722 represents an average probability associated with the event. For example, there may be a 73.3% probability of the event occurring. The probability may be calculated by the human experts or obtained based on information from various other sources. The impact entry 724 represents an impact that is associated with the factor. The impact entry 724 may also represent the impact that the event may have on the domain. The impact may be represented as a number, as depicted in FIG. 7.

The event identification entry enables the human experts to identify the event as a milestone, an option or an implication, as depicted by checkboxes that represent the milestone 726a, the option 726b and the implication 726c, respectively. The identifier data entry 728 enables the human experts to provide the identifier data for an event. The identifier data includes event details 728a, implication of the event 728b, other related events 728c, discussions 728d, shared in projects 728e, options 728f, links related to the event 728g, and attachments related to the event 728h. The identifier data forms the identifier data dimension, as explained previously.

The plurality of entries related to an event may be filled by the human experts. Alternatively, the plurality of entries may be filled by other sources and reviewed for correctness by the human experts in the domain. It will be apparent to a person skilled in the art that the user interface 700 may include greater or fewer number of entries. Further, details of the event that are received from the plurality of entries may be utilized in the formation of a two-dimensional or three-dimensional event field.

A structured, easily readable subset of anticipated future events in the domain may be extracted from the event field assembly 200 and the event field assessment 250, to constitute a future map (or a set of future maps) of the domain. Several future maps having easily readable subset of anticipated future events can be extracted from the event field, depending on the need and scope of the domain. Each extracted future map may convey a particular scenario, a vision of a particular group of human experts, an extract from a specific type of sources, or a picture with a specific time horizon. The future map extracted thereby may be updated and extracted daily to reflect the latest information and analysis.

The future map serves as a unique repository of all information about the future of an organization by providing decision makers an instant view of the anticipated future events and challenges. The extracted future map including the anticipated future events in the domain may also serve as an integration tool, a learning tool, a strategy development tool, a planning tool, and a progress tracking tool for the decision-makers. The future map may bridge the gap between short-term trend extrapolations and long-term scenarios, helping the decision-makers to better understand a time horizon within which majority of policy decisions need to be taken to produce better results. By offering the capacity to show a variety of visions of the future, the future map helps in evaluating scenarios, reconciling conflicting information, understanding alternative perspectives, identifying discontinuities, and examining gaps in knowledge. By focusing on future milestones, the future map forces the decision makers to actively search for early indicators of emerging trends. By assessing the impacts of events across time and across domains, the future map encourages holistic thinking about the future, promotes more systematic and rigorous analysis of the risks and challenges and fosters discussions among all contributors. The future map further facilitates the assessment of probabilities and expected impacts of the events in the domain by providing “decision market” technologies (“prediction market technologies”) with structured sets of events. The future map also enhances early warning systems for corporate by linking strategy, intelligence and learning, and connecting collection and assessment processes. The future map further puts corporate objectives and strategies on a timeline and within context of changing external factors and internal factors.

The future map constituted by the anticipated future events may act as a framework for setting organizational objectives and strategic milestones in relation to the organization's internal factors and external factors, and then tracking the organization's progress towards the objectives. The milestone events assembled in the event field may help the organization to track the progress in achieving the objectives, as well as, track the external factors affecting the performance, such as, the organization's regulatory and competitive environment. The events affecting the future of an organization's customer may also be extracted from the event field, to help the decision makers formulate or adjust the marketing strategy of the organization. Further, the future map may include information obtained during competitive and market intelligence research from Business Units, R&D centers, or external consultants. The future map having structured information of high probability anticipated future events enable the decision-makers in the organization to better understand the information that is needed to make decisions, to formulate and adjust the objectives of the organization.

In one embodiment, the future map may be extracted, and built using programmable instructions forming a software product. The software product may provide appropriate visualization, collaboration tools, automatic search, and extraction tools. The software product may facilitate the creation of a global expert community in an organization (or domain), thereby expanding the organization's capacity to foresee, and to meet future challenges.

Various embodiments may further include receiving, sending or storing instructions and or/data that implement the functionality of assembling, and assessing events for extracting high probability anticipated future events thereby formulating a structured picture of the future, in accordance with the present invention, upon a computer readable medium. Such a computer readable medium may include but is not limited to a storage media or memory media such as magnetic media (e.g., floppy disks), optical media (e.g., disk or CD-ROM), volatile or non volatile media such as Random Access Memory (RAM), Read Only Memory (ROM), and the like, as well as transmission media or signals such as electrical, electromagnetic, or digital signals, conveyed via a communication means such as network and/or wireless link, wherein, when a computer program code, implementing the embodiments of the present invention, is loaded onto and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the invention to the precise forms disclosed, and obviously, many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is clamed is:

1. A method for mapping anticipated future events in a domain, the method comprising:
assembling a multidimensional event field to comprise a depository of events related to the domain, the event field comprising a plurality of dimensions;
assessing the depository of events from the event field to formulate at least one subset having high probability anticipated future events; and
extracting at least one future scenario from the event field based on assessment of the depository of events, wherein each of the at least one future scenario represents a specific picture about a future of the domain.

2. The method of claim 1, wherein the plurality of dimensions of the event field comprise at least a factor dimension, a time dimension and an identifier data dimension.

3. The method of claim 2, wherein the factor dimension of the event field comprises a plurality of factors impacting the domain.

4. The method of claim 3, wherein the plurality of factors include internal factors and external factors.

5. The method of claim 3, wherein the time dimension of the event field comprises a past space, a present space, and a future space for arranging the depository of events, each event of the depository of events related to at least one factor of the plurality of factors.

6. The method of claim 5, wherein the past space comprises time increments corresponding to occurred events of the depository of events, the present space comprises time increments corresponding to occurring events of the depository of events and the future space comprises time increments corresponding to the anticipated future events of the depository of events.

7. The method of claim 2, wherein the identifier data dimension comprises identifier data related to an event of the depository of events, the identifier data comprises at least one of a nature of the event, a strategy of the event, an objective of the event, an implication of the event, a meaning of the event, actions to be taken on occurrence of the event, links and attachments related to the event, and a business environment of the event field.

8. The method of claim 7, wherein an event of the depository of events is related to the identifier data.

9. The method of claim 1, wherein each scenario of the at least one future scenario comprises a set of events of the depository of events, the set of events being inter-related.

10. The method of claim 1, wherein the depository of events are collected from a plurality of sources, the plurality of sources selected from a group comprising web, automatic extraction tools, search tools, newswire reports and human experts.

11. The method of claim 1, wherein assembling the event field for the domain comprises:
(a) defining a plurality of factors impacting the domain, the plurality of factors constituting a dimension of the plurality of dimensions;
(b) defining key repeating events for each factor of the plurality of factors in the domain;
(c) defining a predecessor event and a follower event for each event of the key repeating events;
(d) adding a first subset of the anticipated future events in the event field, the first subset of the anticipated future events occurring at known regular intervals;
(e) adding a second subset of the anticipated future events in the event field by applying trends and projections on the each factor;
(f) adding a third subset of the anticipated future events in the event field based on predictions of developments in the domain by human experts;
(g) identifying at least one first set of events related to the domain for importing in the event field, the at least one first set of events forming at least one existing scenario;
(h) identifying at least one second set of events related to the depository of events of the event field, the at least one second set of events forming at least one additional scenario;
(i) identifying a trigger point for each of the at least one existing scenario and each of the at least one additional scenario, wherein the trigger point is an event initiating at least one of the at least one existing scenario and the at least one additional scenario;
(j) adding a fourth subset of the anticipated future events in the event field based on wild card events and anticipated disruptions in the trends;
(k) adding at least one identifier data associated with the depository of events of the event field, the at least one identifier data forming an identifier data dimension of the plurality of dimensions;
(l) assigning probabilities to each event of the depository of events;
(m) identifying objectives and milestone events associated with the event field; and
(n) adding strategic options and action plans to the event field,
wherein the depository of events are arranged along a time dimension of the plurality of dimensions.

12. The method of claim 11, wherein the key repeating events, predecessor events of the key repeating events, follower events of the key repeating events, the first subset of the anticipated future events, the second subset of the anticipated future events, the third subset of the anticipated future events, the fourth subset of the anticipated future events, the at least one first set of events and the at least one second set of events constitute the depository of events of the event field.

13. The method of claim 11 further comprising collating the depository of events of the event field by repetition of steps (b) to (n) at regular intervals.

14. The method of claim 11 further comprising building the at least one future scenario for at least one factor of the plurality of factors, the at least one factor significantly impacting the domain.

15. The method of claim 11, wherein assessing the depository of events of the event field comprises:
(a) examining the event field to identify irrelevant events of the depository of events in the event field for eliminating the irrelevant events from the event field;
(b) reviewing impact of occurred events of the depository of events on the anticipated future events in the event field;
(c) identifying key anticipated future events of the anticipated future events;
(d) defining and identifying leading indicators of the key anticipated future events for tracking and setting the milestone events;
(e) evaluating probabilities of the key anticipated future events;
(f) reviewing the at least one existing scenario for selecting the at least one second set of events of the depository of events, the at least one second set of events forming the at least one additional scenario;
(g) re-identifying the key anticipated future events in the event field;
(h) assessing impact of the key anticipated future events on the domain;
(i) identifying risks and opportunities associated with the key anticipated future events;
(j) modifying the objectives and the milestone events associated with the depository of events; and
(k) reviewing the strategy options and the action plans in the event field.

16. The method of claim 15 further comprising repeating steps (a) to (k) at regular intervals.

17. The method of claim 15 further comprising:
(a) reviewing the at least one existing scenario impacting the domain;
(b) identifying at least one alternative scenario based on significant factors of the plurality of factors in the domain; and
(c) grouping a third set of events in the event field based on the at least one alternative scenario identified.
